(19) United States
(12) Patent Application Publication
(10) Pub. No.: US 2025/0336996 A1
(43) Pub. Date: Oct. 30, 2025

(54) IMPURITY REMOVAL SYSTEM FOR USE IN A FUEL CELL SYSTEM

(71) Applicant: HYDROGENICS CORPORATION, Mississauga (CA)

(72) Inventor: Jean ST-PIERRE, Indianapolis, IN (US)

(21) Appl. No.: 19/176,479

(22) Filed: Apr. 11, 2025

Related U.S. Application Data
(60) Provisional application No. 63/639,079, filed on Apr. 26, 2024.

(51) Int. Cl. H01M 8/0662; B01D 53/047; H01M 8/0444

(52) U.S. Cl. CPC H01M 8/0662; B01D 53/0476; H01M 8/04447; H01M 8/0687; B01D 2256/16; B01D 2259/40003; B01D 2259/4006; B01D 2259/402

(57) ABSTRACT

A fuel cell system includes a fuel cell, a reactant intake, and an impurity removal system. The fuel cell includes an inlet and an outlet opposite the inlet. The reactant intake is configured to direct a reactant stream toward the inlet of the fuel cell. The impurity removal system is arranged downstream of the reactant intake and configured to remove impurities from the reactant stream to form a purified reactant stream that is directed into the inlet of the fuel cell.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/639,079 filed on Apr. 26, 2024, the entire disclosure of which is hereby expressly incorporated herein by reference.

### TECHNICAL FIELD

The present disclosure relates to an impurity removal system for use in a fuel cell system and methods of using the impurity removal system.

### BACKGROUND

Fuel cell systems are known for their efficient use of fuel to produce direct current electric energy to power mobile applications, such as, for example, vehicles, trains, buses, and trucks. Contaminants and/or impurities may be detrimental to operation of the fuel cell system. Generally, contaminants and/or impurities may be removed from the fuel cell system with a passive filter. Contaminants and/or impurities may also be handled by mandating a purity of reactant streams within the fuel cell system. However, such means may be insufficient to guarantee fuel cell operation over an extended period of time for heavy-duty vehicles and stationary applications without multiple maintenance cycles or increasing hydrogen fuel cost. Thus, it may be advantageous to more efficiently remove contaminants and/or impurities from fuel cell systems.

The present disclosure is directed to an impurity removal system for use in a fuel cell system and methods of using the impurity removal system to remove contaminants and/or impurities from the fuel cell system.

### SUMMARY

Embodiments of the present disclosure are included to meet these and other needs.

According to a first aspect of the present disclosure, a fuel cell system comprises a fuel cell, a reactant intake, and an impurity removal system. The fuel cell includes an inlet and an outlet opposite the inlet. The reactant intake is configured to direct a reactant stream toward the inlet of the fuel cell. The impurity removal system is arranged downstream of the reactant intake and configured to remove impurities from the reactant stream to form a purified reactant stream that is directed into the inlet of the fuel cell. The impurity removal system includes a first adsorbent bed, a second adsorbent bed, a vacuum ejector, and a plurality of valves. The first adsorbent bed changes between a first active state in which the reactant stream is directed through the first adsorbent bed to remove the impurities therefrom and to form the purified reactant stream that is directed into the inlet of the fuel cell, a first desorption state in which the impurities in the first adsorbent bed are purged from the first adsorbent bed via the vacuum ejector and out of an exhaust of the fuel cell system, and a first pressurization state in which the reactant stream is directed into the first adsorbent bed without being directed into the fuel cell to pressurize the first adsorbent bed.

In some embodiments, the second adsorbent bed may change between a second active state in which the reactant stream is directed through the second adsorbent bed to remove the impurities therefrom and to form the purified reactant stream that is directed into the inlet of the fuel cell, a second desorption state in which the impurities in the second adsorbent bed are purged from the second adsorbent bed via the vacuum ejector and out of the exhaust of the fuel cell system, and a second pressurization state in which the reactant stream is directed into the second adsorbent bed without being directed into the fuel cell to pressurize the second adsorbent bed. In some embodiments, in response to the first adsorbent bed being in the first active state, the second adsorbent bed may be in the second desorption state or the second pressurization state. In some embodiments, in response to the second adsorbent bed being in the second active state, the first adsorbent bed may be in the first desorption state or the first pressurization state so that the purified reactant stream is continuously supplied to the inlet of the fuel cell.

In some embodiments, the plurality of valves may include a first valve upstream of the first adsorbent bed, a second valve downstream of the first adsorbent bed, a third valve upstream of the second adsorbent bed, and a fourth valve downstream of the second adsorbent bed. In some embodiments, while the first adsorbent bed is in the first active state, the first valve may be in a first open position and the reactant stream may be directed into the first adsorbent bed through the first valve, and the second valve may be in an open position and the purified reactant stream may be directed through the second valve and into the inlet of the fuel cell.

In some embodiments, while the second adsorbent bed is in the second pressurization state, the third valve may be in a first open position and the reactant stream may be directed through the third valve and into the second adsorbent bed, and the fourth valve may be in a closed position so that the reactant stream is not directed to the fuel cell from the second adsorbent bed and the second adsorbent bed is pressurized via the reactant stream. In some embodiments, while the first adsorbent bed is in the first desorption state, the first valve may be in a second open position different than the first open position of the first valve and the impurities in the first adsorbent bed may be directed through the first valve and out of the first adsorbent bed, through the vacuum ejector, and to the exhaust, and the second valve may be in a closed position. In some embodiments, while the second adsorbent bed is in the second active state, the third valve may be in the first open position and the reactant stream may be directed through the third valve and into the second adsorbent bed, and the fourth valve may be in an open position and the purified reactant stream may be directed through the fourth valve and into the inlet of the fuel cell.

In some embodiments, while the first adsorbent bed is in the first pressurization state, the first valve may be in the first open position and the reactant stream may be directed through the first valve and into the first adsorbent bed, and the second valve may be in the closed position so that the reactant stream is not directed to the fuel cell from the first adsorbent bed and the first adsorbent bed is pressurized via the reactant stream. In some embodiments, while the second adsorbent bed is in the second active state, the third valve may be in the first open position and the reactant stream may be directed through the third valve and into the second adsorbent bed, and the fourth valve may be in the open position and the purified reactant stream may be directed through the fourth valve and into the inlet of the fuel cell.

In some embodiments, while the first adsorbent bed is in the first active state, the first valve may be in the first open position and the reactant stream may be directed through the first valve and into the first adsorbent bed, and the second valve may be in the open position and the purified reactant stream may be directed through the second valve and into the inlet of the fuel cell. In some embodiments, while the second adsorbent bed is in the second desorption state, the third valve may be in a second open position different than the first open position of the third valve and the impurities in the second adsorbent bed may be directed out of the second adsorbent bed through the third valve, through the vacuum ejector, and to the exhaust, and the fourth valve may be in a closed position.

In some embodiments, the impurity removal system may further comprise a first contaminant sensor arranged upstream of the first valve and the third valve. In some embodiments, the impurity removal system may further comprise a second contaminant sensor arranged between the first adsorbent bed and the second valve. In some embodiments, data from the first contaminant sensor and data from the second contaminant sensor may be compared to determine a contaminant removal efficiency of the first adsorbent bed.

In some embodiments, the impurity removal system may further comprise a third contaminant sensor arranged between the second adsorbent bed and the fourth valve. In some embodiments, the data from the first contaminant sensor and data from the third contaminant sensor may be compared to determine a contaminant removal efficiency of the second adsorbent bed. In some embodiments, the fuel cell system may further comprise a filter arranged upstream of the impurity removal system.

According to a further aspect of the present disclosure, a method of operating a fuel cell system comprises arranging an impurity removal system downstream of a reactant intake. The impurity removal system includes a first adsorbent bed, a second adsorbent bed, a vacuum ejector, a first valve, a second valve, a third valve, and a fourth valve. The method includes directing a reactant stream into the reactant intake of the fuel cell system. The method includes changing the first adsorbent bed to a first active state by opening the first valve to a first open position and opening the second valve to an open position. The method includes changing the second adsorbent bed to a second pressurization state by opening the third valve to a first open position and closing the fourth valve to a closed position. The method includes directing the reactant stream through the first valve and into the first adsorbent bed to remove impurities therefrom and to form a purified reactant stream. The method includes directing the reactant stream through the third valve and into the second adsorbent bed to pressurize the second adsorbent bed. The method includes directing the purified reactant stream from the first adsorbent bed, through the second valve, and into the fuel cell.

In some embodiments, the method may further comprise changing the first adsorbent bed to a first desorption state from the first active state by opening the first valve to a second open position different than the first open position and closing the second valve to a closed position, directing the impurities in the first adsorbent bed through the first valve, through the vacuum ejector, and out of an exhaust, changing the second adsorbent bed to a second active state from the second pressurization state by opening the fourth valve to an open position, directing the reactant stream through the third valve, into the second adsorbent bed to remove the impurities therefrom and to form the purified reactant stream, and directing the purified reactant stream from the second adsorbent bed, through the fourth valve, and into the fuel cell. In some embodiments, the method may further comprise changing the first adsorbent bed to a first pressurization state from the first desorption state by opening the first valve to the first open position, and directing the reactant stream through the first valve and into the first adsorbent bed to pressurize the first adsorbent bed.

In some embodiments, the method may further comprise changing the first adsorbent bed to the first active state from the first pressurization state by opening the second valve to the open position, directing the reactant stream through the first valve, into the first adsorbent bed to remove the impurities therefrom and to form the purified reactant stream, and directing the purified reactant stream from the first adsorbent bed, through the second valve, and into the fuel cell.

In some embodiments, the method may further comprise changing the second adsorbent bed to a second desorption state from the second active state by opening the third valve to a second open position different than the first open position of the third valve and closing the fourth valve to the closed position, and directing the impurities in the second adsorbent bed through the third valve, through the vacuum ejector, and out of the exhaust.

In some embodiments, the impurity removal system may include a first contaminant sensor arranged upstream of the first valve and the third valve and a second contaminant sensor arranged between the first adsorbent bed and the second valve. In some embodiments, the method may further comprise comparing data from the first contaminant sensor and data from the second contaminant sensor to determine a contaminant removal efficiency of the first adsorbent bed.

In some embodiments, the impurity removal system may include a third contaminant sensor arranged between the second adsorbent bed and the fourth valve. In some embodiments, the method may further comprise comparing the data from the first contaminant sensor and data from the third contaminant sensor to determine a contaminant removal efficiency of the second adsorbent bed. In some embodiments, the method may further comprise arranging a filter upstream of the impurity removal system.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A is perspective view of an electrolyzer cell stack according to the present disclosure;

FIG. 2B is a schematic view of an electrolysis system configured to utilize the electrolyzer cell stack of FIG. 2A;

FIG. 2C is a schematic view of an additional portion of the electrolysis system of FIG. 2B;

FIG. 3 is a schematic view of a traditional fuel cell system including a passive filter upstream of a fuel cell;

FIG. 4 is a schematic view of a fuel cell system including an impurity removal system upstream of the fuel cell configured to remove impurities and/or contaminants from a reactant stream;

FIG. 5 is a schematic view of a portion of the fuel cell system of FIG. 4 showing that the impurity removal system includes a first adsorbent bed in a first active state and a second adsorbent bed in a second pressurization state;

FIG. 6 is a schematic view of a portion of the fuel cell system of FIG. 4 showing that the first adsorbent bed is in a first desorption state and the second adsorbent bed is in a second active state;

FIG. 7 is a schematic view of a portion of the fuel cell system of FIG. 4 showing that the first adsorbent bed is in a first pressurization state and the second adsorbent bed is in a second active state;

FIG. 8 is a schematic view of a portion of the fuel cell system of FIG. 4 showing that the first adsorbent bed is in the first active state and the second adsorbent bed is in a second desorption state;

FIG. 9 is a graph showing that an amount of adsorption by an adsorbent bed is pressure and temperature dependent;

FIG. 10 is a graph showing exemplary pressure transients for the multiple states of each of the first adsorbent bed and the second adsorbent bed;

FIG. 11 is a schematic view of another embodiment of a fuel cell system including an impurity removal system configured to remove impurities and/or contaminants from a reactant stream; and

FIG. 12 is a schematic view of another embodiment of a fuel cell system including an impurity removal system configured to remove impurities and/or contaminants from a reactant stream.

### DETAILED DESCRIPTION

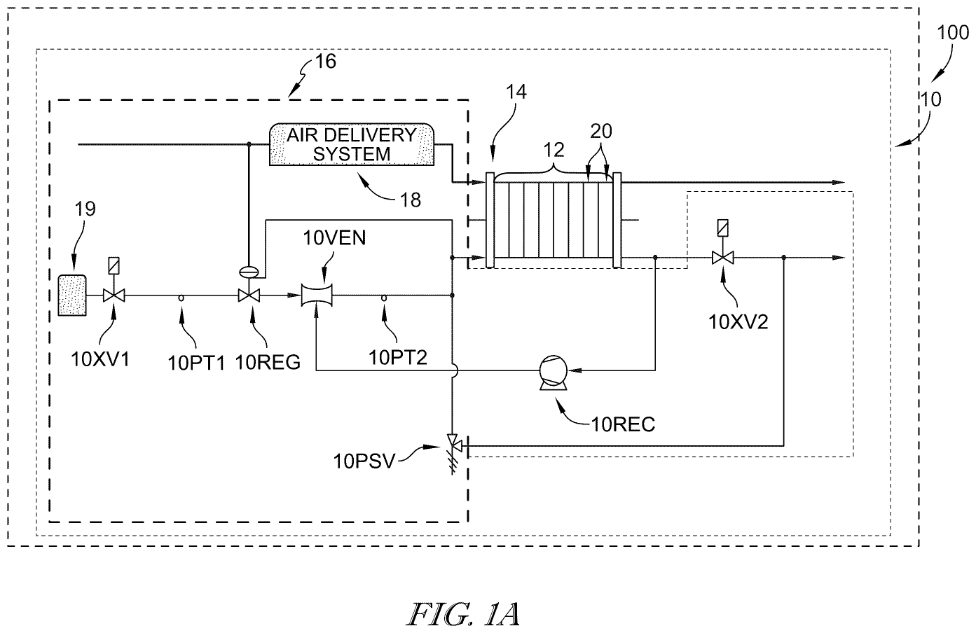

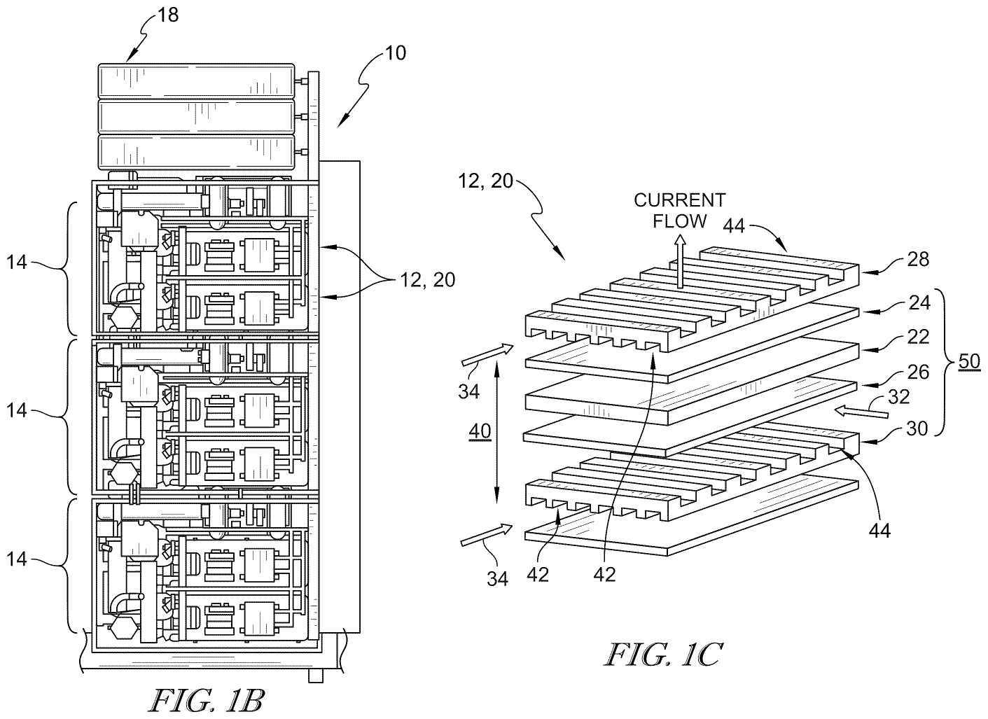

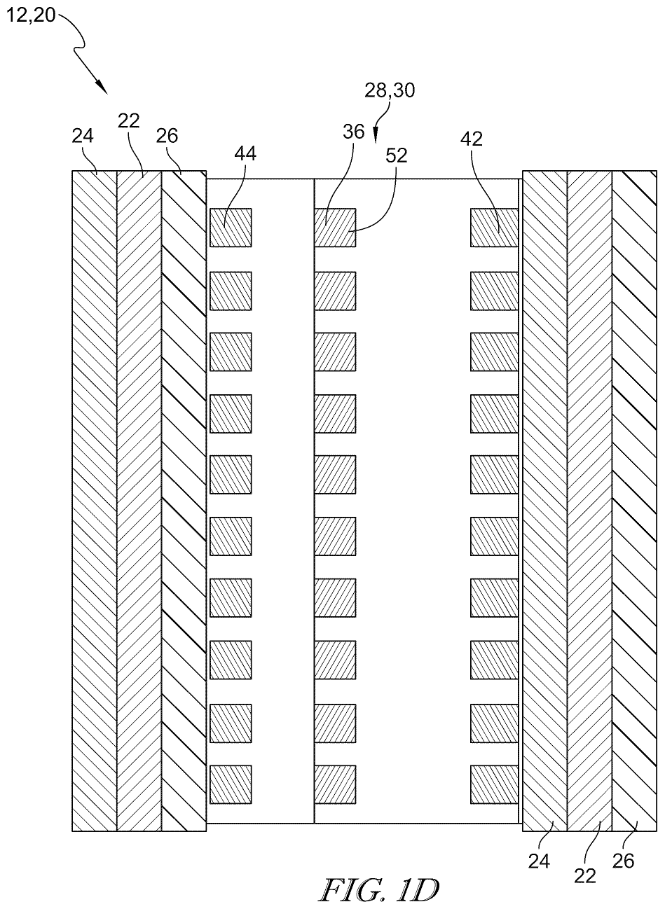

As shown in FIG. 1A, fuel cell systems 10 often include one or more fuel cell stacks 12 or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and IC, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14, as shown in FIGS. 1A and 1B. In some embodiments, the fuel cell system 10 may comprise one or more fuel cell stacks 12.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling liquid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plates (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26. The bipolar plate (BPP) 28, 30 also includes oxidant flow fields 42 for transfer of oxidant 34 on the second, opposite side of the plate 28, 30 for interaction with the gas diffusion layer (GDL) 24.

As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling liquid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19, as shown in FIG. 1A. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV, as shown in FIG. 1A.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a passenger car, a bus, a truck, a train, a locomotive, an aircraft, a light duty vehicle, a medium duty vehicle, or a heavy-duty vehicle. Types of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

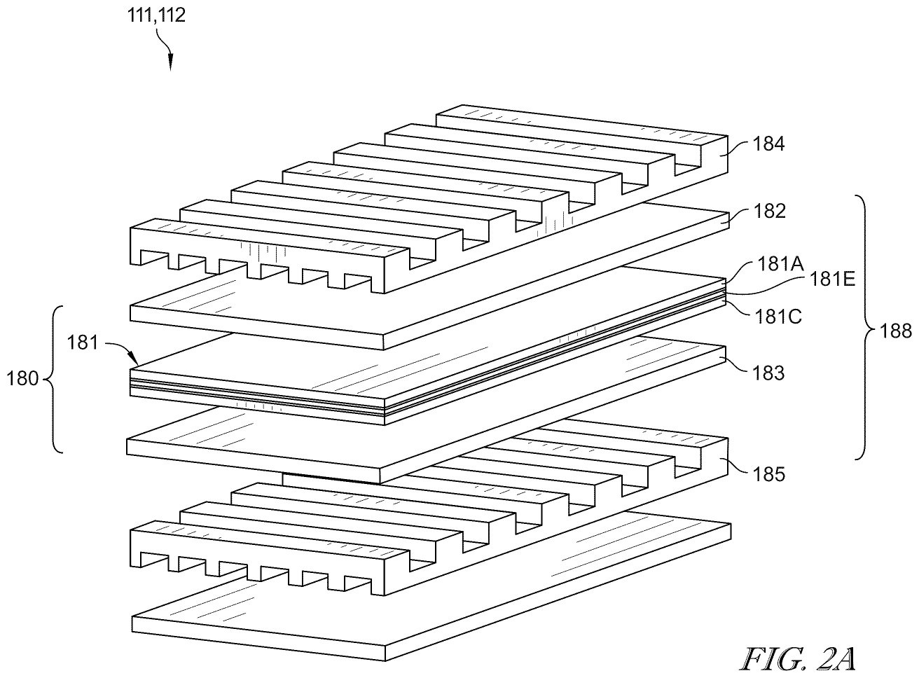

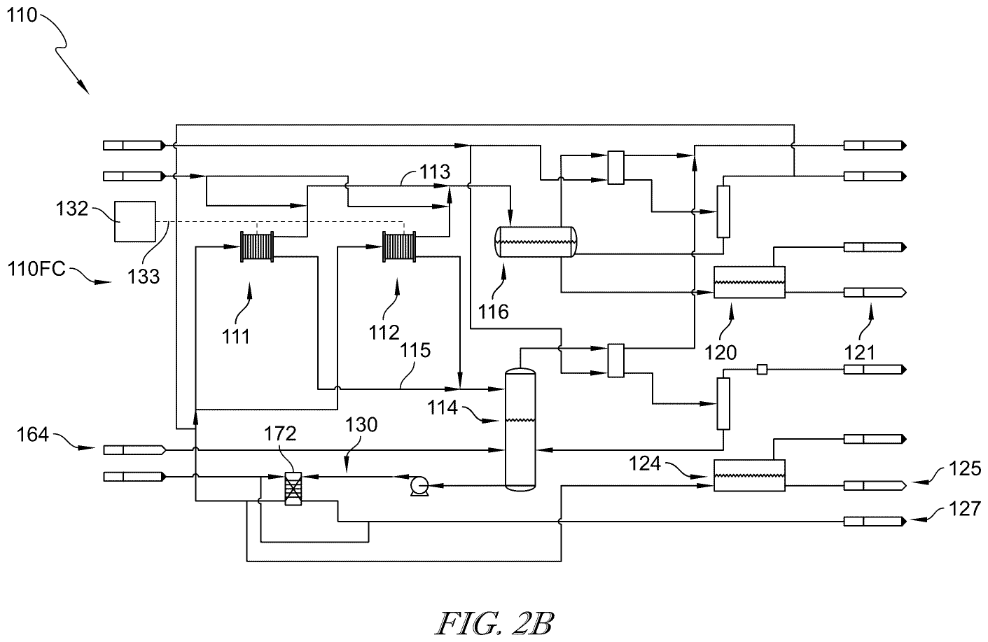

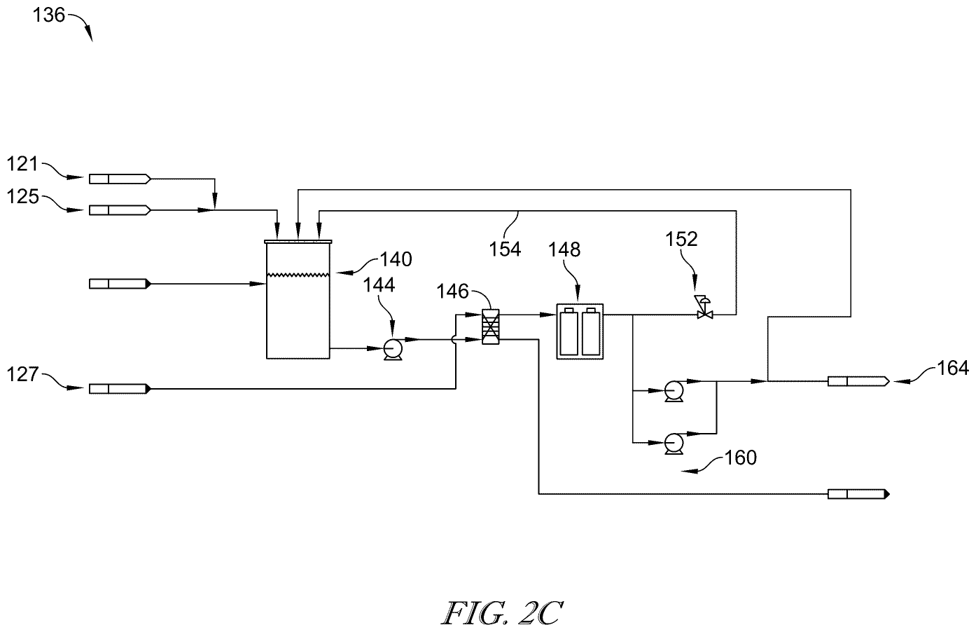

As shown in FIGS. 2A and 2B, electrolysis systems 110 are typically configured to utilize water and electricity to produce hydrogen and oxygen. An electrolysis system 110 typically includes one or more electrolyzer cells 180 that utilize electricity to chemically produce substantially pure hydrogen 113 and oxygen 115 from deionized water 130. Often the electrical source for the electrolysis systems 110 is produced from power or energy generation systems, including renewable energy systems such as wind, solar, hydroelectric, and geothermal sources for the production of green hydrogen. In turn, the pure hydrogen produced by the electrolysis systems 110 is often utilized as a fuel or energy source for those same power generation systems, such as fuel cell systems. Alternatively, the pure hydrogen produced by the electrolysis systems 110 may be stored for later use.

The typical electrolyzer cell 180, or electrolytic cell, is comprised of multiple assemblies compressed and bound into a single assembly, and multiple electrolyzer cells 180 may be stacked relative to each other, along with bipolar plates (BPP) 184, 185 therebetween, to form an electrolyzer cell stack (for example, electrolyzer cell stacks 111, 112 in FIG. 2B). Each electrolyzer cell stack 111, 112 may house a plurality of electrolyzer cells 180 connected together in series and/or in parallel. The number of electrolyzer cell stacks 111, 112 in the electrolysis systems 110 can vary depending on the amount of power required to meet the power need of any load (e.g., fuel cell stack). The number of electrolyzer cells 180 in an electrolyzer cell stack 111, 112 can vary depending on the amount of power required to operate the electrolysis systems 110 including the electrolyzer cell stack 111, 112.

An electrolyzer cell 180 includes a multi-component membrane electrode assembly (MEA) 181 that has an electrolyte 181E, an anode 181A, and a cathode 181C. Typically, the anode 181A, cathode 181C, and electrolyte 181E of the membrane electrode assembly (MEA) 181 are configured in a multi-layer arrangement that enables the electrochemical reaction to produce hydrogen and/or oxygen via contact of the water with one or more gas diffusion layers 182, 183. The gas diffusion layers (GDL) 182, 183, which may also be referred to as porous transport layers (PTL), are typically located on one or both sides of the MEA 181. Bipolar plates (BPP) 184, 185 often reside on either side of the GDLs and separate the individual electrolyzer cells 180 of the electrolyzer cell stack 111, 112 from one another. One bipolar plate 185 and the adjacent gas diffusion layers 182, 183 and MEA 181 can form a repeating unit 188.

As shown in FIGS. 2B and 2C, an exemplary electrolysis system 110 can include two electrolyzer cell stacks 111, 112 and a fluidic circuit 110FC including the various fluidic pathways shown in FIGS. 2B and 2C that is configured to circulate, inject, and purge fluid and other components to and from the electrolysis systems 110. A person skilled in the art would understand that one or a variety of a number of components within the fluidic circuit 110FC, as well as more or less than two electrolyzer cell stacks 111, 112, may be utilized in the electrolysis systems 110. For example, the electrolysis systems 110 may include one electrolyzer cell stack 111, and in other examples, the electrolysis systems 110 may include three or more electrolyzer cell stacks.

The electrolysis systems 110 may include one or more types of electrolyzer cell stacks 111, 112 therein. In the illustrated embodiment, a polymer electrolyte membrane (PEM) electrolyzer cell 180 may be utilized in the stacks 111, 112. A PEM electrolyzer cell 180 typically operates at about 4° C. to about 150° C., including any specific or range of temperatures comprised therein. A PEM electrolyzer cell 180 also typically functions at about 100 bar or less, but can go up to about 1000 bar (including any specific or range of pressures comprised therein), which reduces the total energy demand of the system. A standard electrochemical reaction that occurs in a PEM electrolyzer cell 180 to produce hydrogen is as follows.

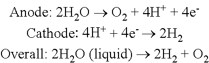

Additionally, a solid oxide electrolyzer cell 180 may be utilized in the electrolysis systems 110. A solid oxide electrolyzer cell 180 will function at about 500° C. to about 1000° C., including any specific or range of temperatures comprised therein. A standard electrochemical reaction that occurs in a solid oxide electrolyzer cell 180 to produce hydrogen is as follows.

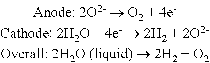

Moreover, an AEM electrolyzer cell 180 may be utilized, which uses an alkaline media. An exemplary AEM electrolyzer cell 180 is an alkaline electrolyzer cell 180. Alkaline electrolyzer cells 180 comprise aqueous solutions, such as potassium hydroxide (KOH) and/or sodium hydroxide (NaOH), as the electrolyte. Alkaline electrolyzer cells 180 typically perform at operating temperatures ranging from about 0°° C. to about 150° C., including any specific or range of temperatures comprised therein. Alkaline electrolyzer cell 180 generally operate at pressures ranging from about 1 bar to about 100 bar, including any specific or range of pressures comprised therein. A typical hydrogen-generating electrochemical reaction that occurs in an alkaline electrolyzer cell 180 is as follows.

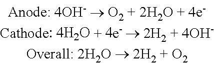

As shown in FIG. 2B, the electrolyzer cell stacks 111, 112 include one or more electrolyzer cells 180 that utilize electricity to chemically produce substantially pure hydrogen and oxygen from water. In turn, the pure hydrogen produced by the electrolyzer may be utilized as a fuel or energy source. As shown in FIG. 2B, the electrolyzer cell stack 111, 112 outputs the produced hydrogen along a fluidic connecting line 113 to a hydrogen separator 116, and also outputs the produced oxygen along a fluidic connecting line 115 to an oxygen separator 114.

The hydrogen separator 116 may be configured to output pure hydrogen gas and also send additional output fluid to a hydrogen drain tank 120, which then outputs fluid to a deionized water drain 121. The oxygen separator 114 may output fluid to an oxygen drain tank 124, which in turn outputs fluid to a deionized water drain 125. A person skilled in the art would understand that certain inputs and outputs of fluid may be pure water or other fluids such as coolant or byproducts of the chemical reactions of the electrolyzer cell stacks 111, 112. For example, oxygen and hydrogen may flow away from the cell stacks 111, 112 to the respective separators 114, 116. The system 110 may further include a rectifier 132 configured to convert electricity 133 flowing to the cell stacks 111, 112 from alternating current (AC) to direct current (DC).

The deionized water drains 121, 125 each output to a deionized water tank 140, which is part of a polishing loop 136 of the fluidic circuit 110FC, as shown in FIG. 2C. Water with ion content can damage electrolyzer cell stacks 111, 112 when the ionized water interacts with internal components of the electrolyzer cell stacks 111, 112. The polishing loop 136, shown in greater detail in FIG. 2C, is configured to deionize the water such that it may be utilized in the cell stacks 111, 112 and not damage the cell stacks 111, 112.

In the illustrated embodiment, the deionized water tank 140 outputs fluid, in particular water, to a deionized water polishing pump 144. The deionized water polishing pump 144 in turn outputs the water to a water polishing heat exchanger 146 for polishing and treatment. The water then flows to a deionized water resin tank 148.

Coolant is directed through the electrolysis systems 110, in particular through a deionized water heat exchanger 172 that is fluidically connected to the oxygen separator 114. The coolant used to cool said water may also be subsequently fed to the water polishing heat exchanger 146 via a coolant input 127 for polishing. The coolant is then output back to the deionized water heat exchanger 172 for cooling the water therein.

After the water is output from the deionized water polishing heat exchanger 146 and subsequently to the deionized water resin tank 148, a portion of the water may be fed to deionized water high pressure feed pumps 160. Another portion of the water may be fed to a deionized water pressure control valve 152, as shown in FIG. 2C. The portion of the water that is fed to the deionized water pressure control valve 152 flows through a recirculation fluidic connection 154 that allows the water to flow back to the deionized water tank 140 for continued polishing.

In some embodiments, the electrolysis systems 110 may increase deionized water skid for polishing water flow to flush out ions within the water at a faster rate. The portion of the water that is fed to the deionized water high pressure feed pumps 160 is then output to a deionized water feed 164, which then flows into the oxygen separator 114 for recirculation and eventual reusage in the electrolyzer cell stacks 111, 112. This process may then continuously repeat.

The electrolysis systems 110 described herein, may be used in stationary and/or immovable power system, such as industrial applications and power generation plants. The electrolysis systems 110 may also be implemented in conjunction with other electrolysis systems 110.

The present electrolysis systems 110 may be comprised in mobile applications. The electrolysis systems 110 may be in the vehicle or the powertrain 100. The vehicle or powertrain 100 comprising the electrolysis systems 110 may be an automobile, a pass car, a bus, a truck, a train, a locomotive, an aircraft, a light duty vehicle, a medium duty vehicle, or a heavy-duty vehicle.

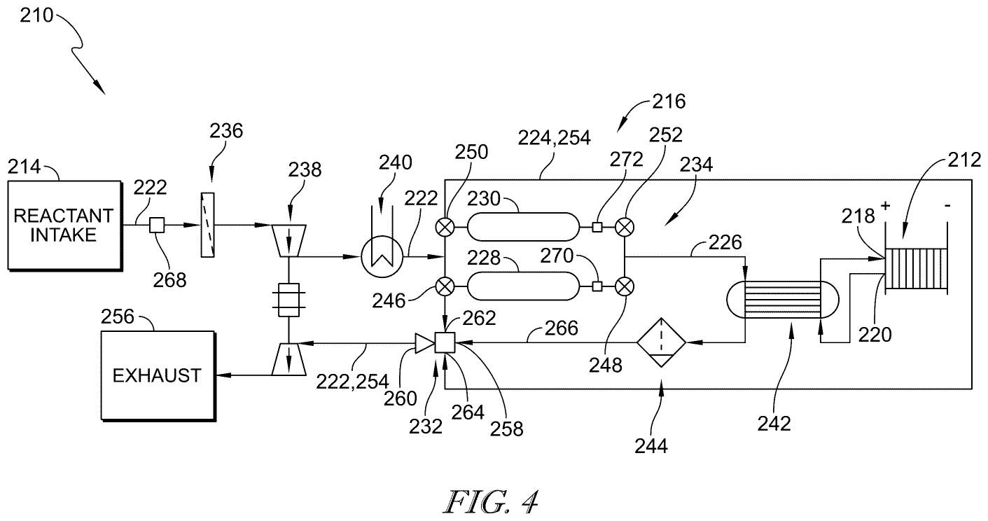

The present disclosure provides an impurity removal system 216 for use in a fuel cell system 210, as shown in FIG. 4. The fuel cell system 210 includes a fuel cell 212, a reactant intake 214, and the impurity removal system 216. The fuel cell 212 includes an inlet 218 and an outlet 220 opposite the inlet 218. The fuel cell 212 may be the fuel cell 20 described above.

The reactant intake 214 is configured to inject and/or direct a reactant stream 222 into the fuel cell system 210, as shown in FIG. 4. In some embodiments, the reactant stream 222 comprises air. The impurity removal system 216 is arranged between the reactant intake 214 and the fuel cell 212. The impurity removal system 216 is configured to remove contaminants and/or impurities 224 from the reactant stream 222 to form a purified reactant stream 226. The purified reactant stream 226 is directed into the inlet 218 of the fuel cell 212. The impurity removal system 216 includes a first adsorbent bed 228, a second adsorbent bed 230, a vacuum ejector 232, and/or a plurality of valves 234, as shown in FIG. 4.

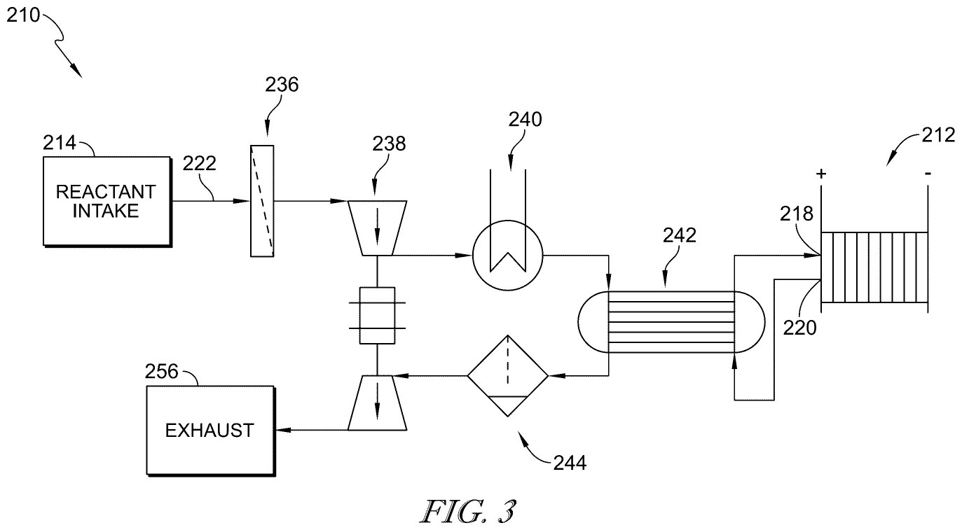

Impurities and/or contaminants may be detrimental to operations of the fuel cell 212. Traditionally, impurities and/or contaminants may be removed with a passive filter 236 or impurities and/or contaminants may be prevented by mandating a purity of the reactant stream 222. However, such means may be insufficient to guarantee fuel cell operation over an extended period of time for heavy-duty vehicles and stationary applications without multiple maintenance cycles (i.e., passive filter replacements) or increasing hydrogen fuel cost. Traditional fuel cell systems 210, as shown in FIG. 3, include a passive filter 236, a turbocompressor 238, an intercooler 240, a humidifier 242, and/or a condenser 244. These components condition atmospheric air (i.e., the reactant stream 222) and ensure that the pressure, the temperature, the relative humidity, the composition, and the flow rate of the reactant stream 222 are compatible with fuel cell operation. The passive filter 236 has a fixed capacity and may need to be replaced on a regular basis. Methods to detect the end of life of the passive filter 236 are usually not provided in traditional fuel cell systems 210 to minimize cost of the fuel cell systems 210. Furthermore, sensors that are sensitive to all relevant impurity species are not available. As a result, traditional fuel cell systems 210 may not be robust enough to capture all impurities and may be susceptible to premature fuel cell failure in environments with high impurity levels.

As such, the impurity removal system 216 is integrated with the fuel cell system 210, as shown in FIG. 4, as an active filtration means within the fuel cell system 210. The impurity removal system 216 may act as a pressure and vacuum swing adsorption system. The impurity removal system 216 is not prone to impurity accumulation because the impurities captured by the impurity removal system 216 are exhausted out of the impurity removal system 216.

The impurity removal system 216 is integrated within the fuel cell system 210 for removal of air (i.e., the reactant stream 222) including compressor oil and hydrogen impurities and/or contaminants 224, which enables maintenance and fuel cost reductions while enhancing the robustness of the fuel cell system 210. The integrated impurity removal system 216 leverages the low concentration of impurities and/or contaminants (ppb to ppm) 224, the availability of effective adsorbents for many species of impurities 224, and the presence of a fuel cell exhaust stream 266 for desorption to minimize the impurity removal system 216 size and complexity.

The reactant stream 222 is directed into the reactant intake 214, as shown in FIG. 4. The reactant stream 222 passes through the passive filter 236, which captures and/or removes any particulates and/or dust from the reactant stream 222. The reactant stream 222 then passes through the turbocompressor 238 and the intercooler 240.

In the illustrative embodiment, the plurality of valves 234 includes a first valve 246, a second valve 248, a third valve 250, and/or a fourth valve 252, as shown in FIGS. 4-8. The first valve 246 is arranged between the intercooler 240 and the first adsorbent bed 228. The second valve 248 is arranged between the first adsorbent bed 228 and the humidifier 242. The second valve 248 is arranged upstream of the inlet 218 of the fuel cell 212. The third valve 250 is arranged between the intercooler 240 and the second adsorbent bed 230. The fourth valve 252 is arranged between the second adsorbent bed 230 and the humidifier 242. The fourth valve 252 is arranged upstream of the inlet 218 of the fuel cell 212. The first adsorbent bed 228 is located between the first valve 246 and the second valve 248. The second adsorbent bed 230 is located between the third valve 250 and the second valve 248.

The first valve 246 and the third valve 250 are each three-way valves, as suggested in FIG. 5-8. The second valve 248 and the fourth valve 252 are each two-way, on-off valves.

The first adsorbent bed 228 changes between a first active state, a first desorption state, and a first pressurization state, as shown in FIGS. 5-8. The second adsorbent bed 230 changes between a second active state, a second desorption state, and a second pressurization state, as shown in FIGS. 5-8. One of the adsorbent beds 228, 230 is in the active state at all times to ensure that the fuel cell 212 has a continuous supply of the purified reactant stream 226.

In the first active state of the first adsorbent bed 228, as shown in FIG. 5, the first valve 246 is in a first open position and the second valve 248 is in an open position. The reactant stream 222 is directed through the first valve 246 and to the first adsorbent bed 228 to remove the impurities 224 therefrom and to form the purified reactant stream 226. The purified reactant stream 226 is directed through the second valve 248 and into the inlet 218 of the fuel cell 212.

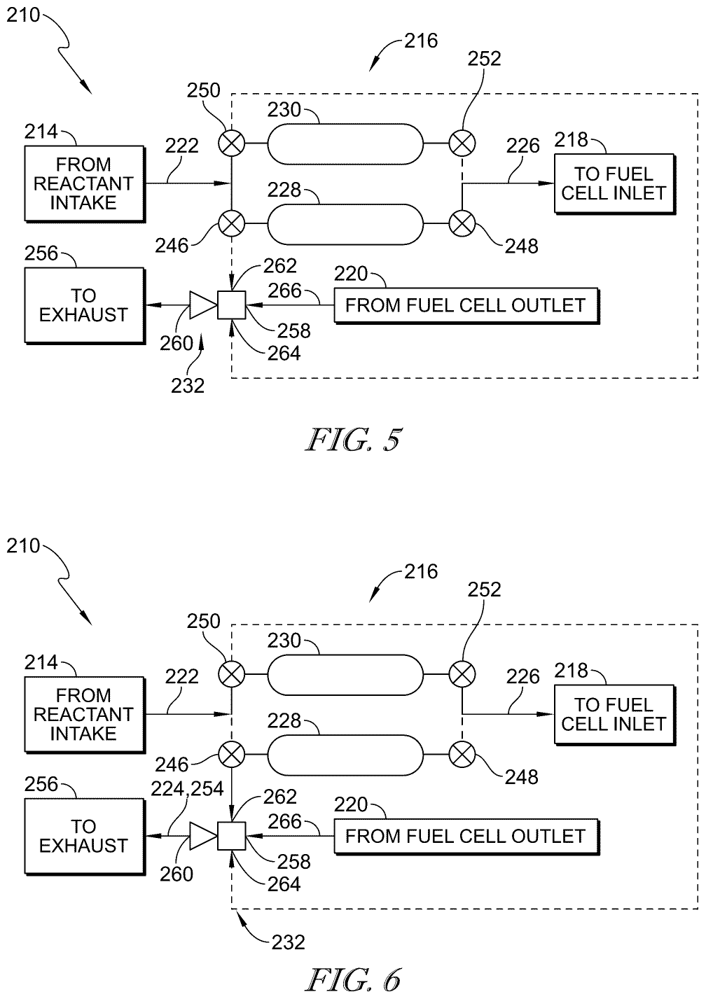

While the first adsorbent bed 228 is in the first active state, the second adsorbent bed 230 is in either the second pressurization state, as shown in FIG. 5, or the second desorption state, as shown in FIG. 8, which will be described in more detail below. From the first active state, the first adsorbent bed 228 changes to the first desorption state, as shown in FIG. 6.

In the first desorption state of the first adsorbent bed 228, as shown in FIG. 6, the first valve 246 is in a second open position different from the first open position and the second valve 248 is in a closed position so that the first adsorbent bed 228 is not fluidly coupled to the fuel cell 212. The first valve 246 fluidly couples the vacuum ejector 232 to the first adsorbent bed 228.

The vacuum ejector 232 includes an inlet port 258, an outlet port 260, a first suction port 262, and/or a second suction port 264, as shown in FIGS. 4 and 6. The inlet port 258 is fluidly coupled with the outlet 220 of the fuel cell 212 to receive a fuel cell exhaust stream 266 therefrom. The outlet port 260 is fluidly coupled with an exhaust 256 of the fuel cell system 210. The first suction port 262 is fluidly coupled with the first adsorbent bed 228 through the first valve 246. The second suction port 264 is fluidly coupled with the second adsorbent bed 230 through the third valve 250.

Turning back to the first desorption state of the first adsorbent bed 228, within an impurity exhaust stream 254, the impurities 224 in the first adsorbent bed 228 are purged from the first adsorbent bed 228 via the vacuum ejector 232, as shown in FIG. 6. The impurity exhaust stream 254 (and the impurities 224 contained therein) are directed through the first valve 246, through the first suction port 262 of the vacuum ejector 232, out of the outlet port 260 of the vacuum ejector 232, and out of the exhaust 256 of the fuel cell system 210. The fuel cell exhaust stream 266 provides the aspiration necessary for the desorption of the first adsorbent bed 228. In the first desorption state, a pressure of the first adsorbent bed 228 is decreased. While the first adsorbent bed 228 is in the first desorption state, the second adsorbent bed 230 is in the second active state, as shown in FIG. 6, which will be described in more detail below.

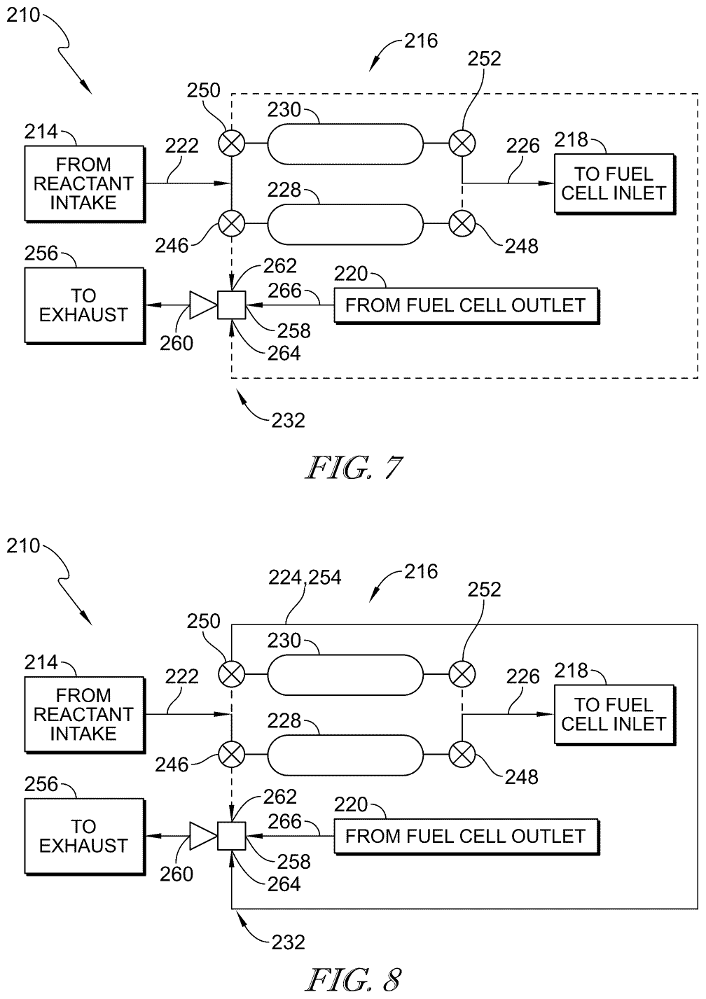

From the first desorption state, the first adsorbent bed 228 changes to the first pressurization state, as shown in FIG. 7. In the first pressurization state of the first adsorbent bed 228, the first valve 246 is in the first open position and the second valve 248 is in the closed position so that the first adsorbent bed 228 is not fluidly coupled to the fuel cell 212. The first valve 246 fluidly couples the reactant intake 214 to the first adsorbent bed 228. The reactant stream 222 is directed through the first valve 246 and into the first adsorbent bed 228. Because the second valve 248 is in the closed position, the first adsorbent bed 228 is pressurized to increase the pressure of the first adsorbent bed 228. While the first adsorbent bed 228 is in the first pressurization state, the second adsorbent bed 230 is in the second active state, as shown in FIG. 7.

The impurity removal system 216 relies, at least partially, on the pressure dependence of gas adsorbed on an adsorbent surface of the adsorbent beds 228, 230, as shown in FIG. 9. Typically, a larger amount of a given impurity 224 species is adsorbed at a higher pressure. Thus, the adsorbent beds 228, 230 each have a pressurization state in which the adsorbent bed 228, 230 is pressurized so that the adsorbent bed 228, 230 adsorbs more impurities and/or contaminants 224 while in the active state.

As previously described, while the first adsorbent bed 228 is in the first pressurization state, the second adsorbent bed 230 is in the second active state, as shown in FIG. 7. In addition, while the first adsorbent bed 228 is in the first desorption state, the second adsorbent bed 230 is in the second active state, as shown in FIG. 6. In the second active state, the third valve 250 is in a first open position to fluidly couple the reactant intake 214 to the second adsorbent bed 230. The fourth valve 252 is in an open position to fluidly couple the second adsorbent bed 230 to the fuel cell 212. The reactant stream 222 is directed through the third valve 250 and into the second adsorbent bed 230. The reactant stream 222 is directed through the second adsorbent bed 230 to remove the impurities 224 therefrom and to form the purified reactant stream 226 that is directed through the fourth valve 252 and into the inlet 218 of the fuel cell 212.

After the second adsorbent bed 230 is in the second active state, the second adsorbent bed 230 changes to the second desorption state, as shown in FIG. 8. In the second desorption state of the second adsorbent bed 230, the third valve 250 is in a second open position different from the first open position and the fourth valve 252 is in a closed position so that the second adsorbent bed 230 is not fluidly coupled to the fuel cell 212. The third valve 250 fluidly couples the vacuum ejector 232 to the second adsorbent bed 230. Within the impurity exhaust stream 254, the impurities 224 in the second adsorbent bed 230 are purged from the second adsorbent bed 230 via the vacuum ejector 232. The impurity exhaust stream 254 (and the impurities 224 contained therein) are directed through the third valve 250, into the second suction port 264 of the vacuum ejector 232, out of the outlet port 260 of the vacuum ejector 232, and out of the exhaust 256 of the fuel cell system 210. Importantly, the impurities 224 contained in one of the adsorbent beds 228, 230 are not purged or discharged into the other of the adsorbent beds 228, 230.

After the second adsorbent bed 230 is in the second desorption state, the second adsorbent bed 230 changes to the second pressurization state, as shown in FIG. 5. In the second pressurization state of the second adsorbent bed 230, the third valve 250 is in the first open position and the fourth valve 252 is in a closed position so that the second adsorbent bed 230 is not fluidly coupled to the fuel cell 212. The third valve 250 fluidly couples the reactant intake 214 to the second adsorbent bed 230. The reactant stream 222 is directed through the third valve 250 and into the second adsorbent bed 230. Because the fourth valve 252 is in the closed position, the second adsorbent bed 230 is pressurized. While the second adsorbent bed 230 is in the second pressurization state, the first adsorbent bed 228 is in the first active state, as shown in FIG. 5.

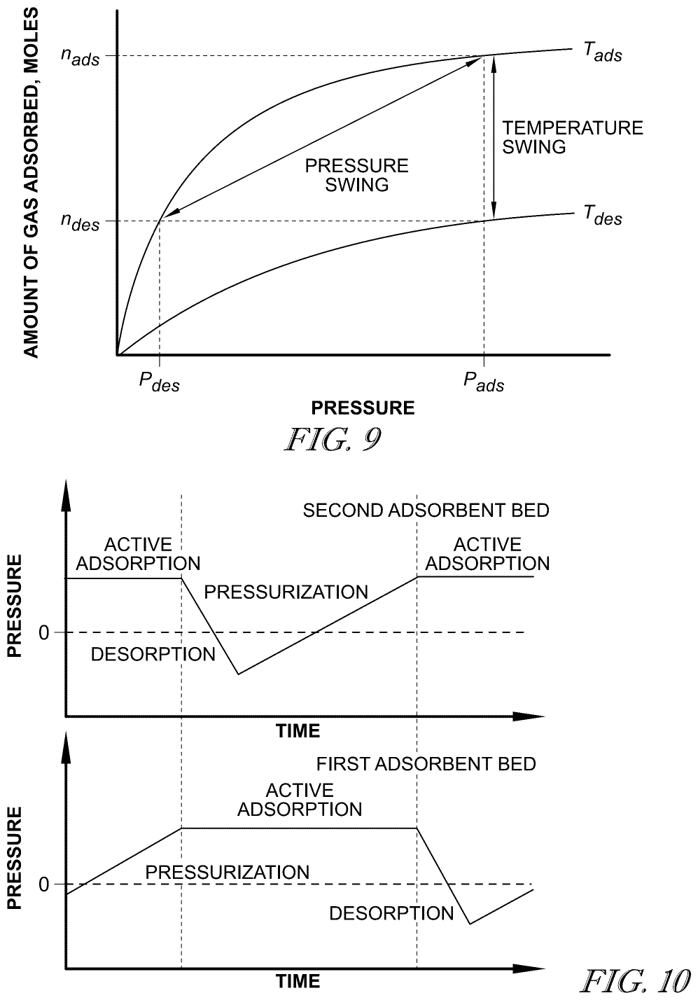

One of the adsorbent beds 228, 230 is in the active state at all times to allow for a constant purified reactant stream 226 for the fuel cell 212, as shown in FIGS. 5-8. As shown in FIG. 10, the pressure of each of the adsorbent beds 228, 230 changes over time as the adsorbent beds 228, 230 change between each state. The active state of one of the beds 228, 230 is complementary to the active state of the other of the beds 228, 230, as shown in FIG. 10. Though the changes in pressure of FIG. 10 are shown as being linear changes, the pressure changes within each adsorbent bed 228, 230 may not be linear. For example, changing the pressure within the adsorbent beds 228, 230 too quickly may cause damage to the adsorbent beds 228, 230 or other components of the fuel cell system 210.

In some embodiments, the reactant stream 222 is directed over the adsorbent beds 228, 230 (i.e., above an adsorbent surface of the adsorbent beds 228, 230). In some embodiments, the reactant stream 222 is directed through the adsorbent beds 228, 230.

Preferably, adsorbent beds 228, 230 with a small adsorbent inventory dictated by the low contaminant concentrations and relatively short cycle duration (in comparison to conventional filter replacement schedules) and configured to treat high gas volumes are designed to minimize the pressure drop (thereby maintaining high system energy efficiency) in a compact and small volume (thereby maintaining high system energy and power densities). Small adsorbent inventory may refer to less than about 2.3 grams/kilowatt-hour or between about 2.3grams/kilowatt-hour to about 3.8 grams/kilowatt-hour, including any specific number or range of numbers comprised therein. Low contaminant concentrations may refer to sub part per billion to part per million by volume range.

Relatively short cycle duration may refer to about 1 hour to about 4 weeks, including any range or specific time period comprised therein. Conventional filter replacement schedules may refer to about 1 month to about 2 years, including any range or specific time period comprised therein.

High gas volume rates for air may refer to about 25 to about 100 liter/minute kilowatt, including any specific number or range of volume rates comprised therein. High gas volume rates for hydrogen may also refer to about 8 to about 32 liter/minute kilowatt, including any specific number or range of volume rates comprised therein. Small volume rates of the adsorbent beds 228, 230 may refer to less than about 0.021 liter/minute kilowatt or about 0.021 to about 0.51 liter/minute kilowatt, including any specific number or range of volume rates comprised therein.

High porosity hierarchical structures may have a porosity of about 0.4 to about 0.6, including any specific porosity number or range of porosity comprised therein. High porosity hierarchical structures may include, but are not limited to, beads, honeycombs, monoliths, and laminates. These high porosity hierarchical structure embodiments may also be embedded with microporous adsorbent particles (e.g., zeolites, metal organic frameworks, activated carbons, etc.), which may be preferred in some circumstances to minimize mass transfer resistances.

In some embodiments, the impurity removal system 216 includes additional adsorbent beds and/or additional valves. For example, additional adsorbent beds and/or additional valves may be included in the impurity removal system 216 for redundancy in case of failure of the adsorbent beds 228, 230 and/or the valves 234. As another example, additional adsorbent beds and/or additional valves may be included in the impurity removal system 216 to increase efficiency of the impurity removal system 216. In some embodiments, the impurities 224 adsorb to the adsorbent beds 228, 230, meaning the impurities 224 adhere to the adsorbent surface of the adsorbent beds 228, 230. In some embodiments, the impurities 224 absorb to the adsorbent beds 228, 230, meaning the impurities 224 are taken into (or soaked up by) the adsorbent beds 228, 230.

In some embodiments, the impurity removal system 216 includes a first contaminant sensor 268, a second contaminant sensor 270, and/or a third contaminant sensor 272, as shown in FIG. 4. The first contaminant sensor 268 is arranged upstream of the adsorbent beds 228, 230. In some embodiments, the first contaminant sensor 268 is arranged upstream of the passive filter 236. Though shown as being upstream of the passive filter 236 in FIG. 4, the first contaminant sensor 268 may be located anywhere upstream of the impurity removal system 216. The second contaminant sensor 270 is arranged downstream of the first adsorbent bed 228. The second contaminant sensor 270 may be arranged upstream or downstream of the second valve 248. The third contaminant sensor 272 is arranged downstream of the second adsorbent bed 230. The third contaminant sensor 272 may be arranged upstream or downstream of the fourth valve 252. In some embodiments, the first contaminant sensor 268 is omitted. In some embodiments, the second contaminant sensor 270 and/or the third contaminant sensor 272 is omitted.

Data from the first contaminant sensor 268 and data from the second contaminant sensor 270 may be used to calculate and/or determine a contaminant removal efficiency of the first adsorbent bed 228. The difference in the data from each of the contaminant sensors 268, 270 may be used to determine if the purified reactant stream 226 contains impurity and/or contaminant levels that exceed established specifications.

Data from the first contaminant sensor 268 and data from the third contaminant sensor 272 may be used to calculate and/or determine a contaminant removal efficiency of the second adsorbent bed 230. The difference in the data from each of the contaminant sensors 268, 272 may be used to determine if the purified reactant stream 226 contains impurity and/or contaminant levels that exceed established specifications.

For example, the data may indicate that the adsorbent bed 228, 230 is not working properly (i.e., may need to be replaced) or that the adsorbent bed 228, 230 is aging (i.e., not working as efficiently, so the cycle time of each state should be reduced). As another example, the data may indicate that the adsorbent bed 228, 230 needs to be changed to the desorption state sooner. The contaminant sensors 268, 270, 272 may be used to tune when the adsorbent beds 228, 230 change from the active state to the desorption state (i.e., decrease or increase the cycle time).

As another example, if the fuel cell system 210 is being moved to a region with a higher concentration of impurities and/or contaminants, the cycle time may be reduced so that the adsorbent beds 228, 230 change from the active state to the desorption state sooner (i.e., the adsorbent beds 228, 230 are purged more often). Tuning the cycle time of each of the adsorbent beds 228, 230 increases the life of the fuel cell system 210 and the impurity removal system 216. The cycle time is tuned to what is necessary, in order to prevent overuse of the components of the impurity removal system 216 (overuse of the valves 246, 248, 250, 252 through opening and closing). As an additional example, fatigue induced by continuous changes in pressure of the adsorbent beds 228, 230 may also affect component health. Additionally, attrition may occur, which may lead to flow channeling and a reduction in contaminant removal efficiency.

The adsorbent beds 228, 230 may be modified by using different adsorbents within the adsorbent beds 228, 230 that target different species of contaminants and/or impurities 224. The composition of the adsorbent beds 228, 230 may be altered to address local conditions, such as volcanic, marine, and urban environments. In some embodiments, a condenser may be arranged upstream of the impurity removal system 216 as some adsorbents may be sensitive to water.

The condenser may be integrated with the intercooler 240. The temperature of the intercooler 240 may be controlled at a lower temperature value, such as about 20° C. to about 40° C., including any specific temperature or range of temperatures comprised therein. The temperature of the intercooler 240 may be controlled with an impurity removal subsystem to maximize its efficiency because species (i.e., impurities 224) more readily adsorb at the lower temperature (e.g., 20° C. to 40° C., including any specific temperature or range of temperatures comprised therein).

Pressure swing adsorption systems operate at about 20° C. to about 40° C., including any specific temperature or range of temperatures comprised therein. The temperature of operating these pressure swing adsorption systems is typically lower than operation of a proton exchange membrane fuel cell temperature at about 60° C. to about 95° C., including any specific temperature or range of temperatures comprised therein.

The impurity removal system 216 may be used with an electrolyzer system instead of the fuel cell system 210. For example, the impurity removal system 216 may be used with an electrolyzer cell, such as the electrolyzer cell 180 as described above. In such an embodiment, the impurity removal system 216 may undergo changes to adapt to the electrolyzer cell 180. Specifically, the impurity removal system 216 may supplement or replace downstream oxygen and hydrogen purification processes (water, hydrogen, or oxygen removal).

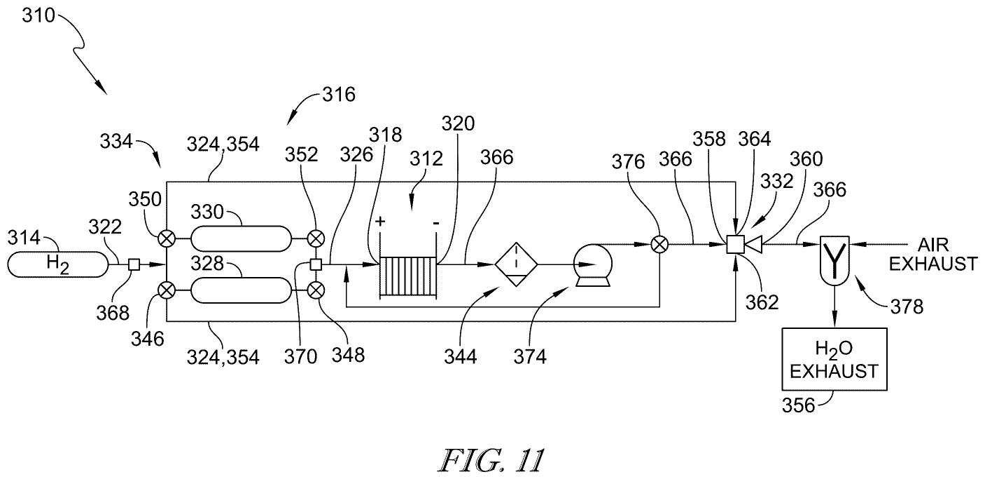

The present disclosure provides an alternative impurity removal system 316 for use with an alternative fuel cell system 310. FIG. 11 illustrates another embodiment of an impurity removal system 316 that is substantially similar to the impurity removal system 216. In the absence of disclosure to the contrary, the features and components of the impurity removal system 216 and the fuel cell system 210 are applicable and present for the impurity removal system 316 and the fuel cell system 310.

The fuel cell system 310 includes a fuel cell 312, a reactant intake 314, and the impurity removal system 316, as shown in FIG. 11. The fuel cell system 310 further includes a condenser 344, a recirculation pump 374, a purge valve 376, and a mixer 378. The fuel cell 312 includes an inlet 318 and an outlet 320 opposite the inlet 318. The reactant intake 314 is illustratively a hydrogen storage tank configured to inject and/or direct a reactant stream 322 toward the inlet 318 of the fuel cell 312. The purge valve 376 is a three-way valve. The purge valve 376 directs hydrogen 366 (i.e., a fuel cell exhaust stream 366) from the recirculation pump 374 back toward the inlet 318 of the fuel cell 312 as recirculated hydrogen, as shown in FIG. 11. Periodically, the purge valve 376 directs hydrogen 366 toward the mixer 378. The mixer 378 mixes the hydrogen 366 with air exhaust to form water that is exhausted to atmosphere. The hydrogen purge minimizes the accumulation of nitrogen diffusing through the fuel cell 312 and other contaminants and/or impurities within the hydrogen.

The impurity removal system 316 is arranged downstream of the reactant intake 314, as shown in FIG. 11. The impurity removal system 316 is configured to remove impurities 324 from the reactant stream 322 to form a purified reactant stream 326. The purified reactant stream 326 is directed into the inlet 318 of the fuel cell 312. The impurity removal system 316 includes a first adsorbent bed 328, a second adsorbent bed 330, a vacuum ejector 332, and/or a plurality of valves 334, as shown in FIG. 11.

In the illustrative embodiment, the plurality of valves 334 includes a first valve 346, a second valve 348, a third valve 350, and/or a fourth valve 352, as shown in FIG. 11. The first valve 346 is arranged between the reactant intake 314 and the first adsorbent bed 328. The second valve 348 is arranged between the first adsorbent bed 328 and the inlet 318 of the fuel cell 312. The third valve 350 is arranged between the reactant intake 314 and the second adsorbent bed 330. The fourth valve 352 is arranged between the second adsorbent bed 330 and the inlet 318 of the fuel cell 312. The first adsorbent bed 328 is located between the first valve 346 and the second valve 348. The second adsorbent bed 330 is located between the third valve 350 and the fourth valve 352.

The first adsorbent bed 328 operates the same as the first adsorbent bed 228 previously described by changing between a first active state, a first desorption state, and a first pressurization state, as shown in FIGS. 5-8. The second adsorbent bed 330 operates the same as the second adsorbent bed 230 previously described by changing between a second active state, a second desorption state, and a second pressurization state, as shown in FIGS. 5-8.

In the first active state of the first adsorbent bed 328, the first valve 346 is in a first open position and the second valve 348 is in an open position. The reactant stream 322 is directed through the first valve 346 and to the first adsorbent bed 328 to remove the impurities 324 therefrom and to form the purified reactant stream 326. The purified reactant stream 326 is directed through the second valve 348 and into the inlet 318 of the fuel cell 312. From the first active state, the first adsorbent bed 328 changes to the first desorption state.

During purge, the purge valve 376 directs hydrogen 366 through the vacuum ejector 332 and to the mixer 378, as shown in FIG. 11. At the same time, the first adsorbent bed 328 changes to the first desorption state. The purge of the hydrogen 366 is leveraged to complete the first desorption state. In the first desorption state of the first adsorbent bed 328, the first valve 346 is in a second open position different from the first open position and the second valve 348 is in a closed position so that the first adsorbent bed 328 is not fluidly coupled to the fuel cell 312. The first valve 346 fluidly couples the vacuum ejector 332 to the first adsorbent bed 328.

The vacuum ejector 332 includes an inlet port 358, an outlet port 360, a first suction port 362, and/or a second suction port 364, as shown in FIG. 11. The inlet port 358 is fluidly coupled with the recirculation pump 374 through the purge valve 376 to receive the hydrogen 366 therefrom. The outlet port 360 is fluidly coupled with the mixer 378 and an exhaust 356 of the fuel cell system 310. The first suction port 362 is fluidly coupled with the first adsorbent bed 328 through the first valve 346. The second suction port 364 is fluidly coupled with the second adsorbent bed 330 through the third valve 350.

Within an impurity exhaust stream 354, the impurities 324 in the first adsorbent bed 328 are purged from the first adsorbent bed 328 via the vacuum ejector 332, as shown in FIG. 11. The impurity exhaust stream 354 (and the impurities 324 contained therein) are directed through the first valve 346, through the first suction port 362 of the vacuum ejector 332, out of the outlet port 360 of the vacuum ejector 332, to the mixer 378, and out of the exhaust 356 of the fuel cell system 310. The hydrogen 366, during purge, provides the aspiration necessary for the desorption of the first adsorbent bed 328.

From the first desorption state, the first adsorbent bed 328 changes to the first pressurization state. In the first pressurization state of the first adsorbent bed 328, the first valve 346 is in the first open position and the second valve 348 is in the closed position so that the first adsorbent bed 328 is not fluidly coupled to the fuel cell 312. The first valve 346 fluidly couples the reactant intake 314 to the first adsorbent bed 328. The reactant stream 322 is directed through the first valve 346 and into the first adsorbent bed 328. Because the second valve 348 is in the closed position, the first adsorbent bed 328 is pressurized.

While the first adsorbent bed 328 is in the first pressurization state, the second adsorbent bed 330 is in the second active state. In the second active state, the third valve 350 is in a first open position to fluidly couple the reactant intake 314 to the second adsorbent bed 330. The fourth valve 352 is in an open position to fluidly couple the second adsorbent bed 330 to the fuel cell 312. The reactant stream 322 is directed through the third valve 350 and into the second adsorbent bed 330 to remove the impurities 324 therefrom and to form the purified reactant stream 326 that is directed through the fourth valve 352 and into the inlet 318 of the fuel cell 312.

After the second adsorbent bed 330 is in the second active state, the second adsorbent bed 330 changes to the second desorption state. In the second desorption state of the second adsorbent bed 330, which occurs during purge of the hydrogen 366 through the purge valve 376, the third valve 350 is in a second open position different from the first open position and the fourth valve 352 is in a closed position so that the second adsorbent bed 330 is not fluidly coupled to the fuel cell 312. The third valve 350 fluidly couples the vacuum ejector 332 to the second adsorbent bed 330. Within the impurity exhaust stream 354, the impurities 324 in the second adsorbent bed 330 are purged from the second adsorbent bed 330 via the vacuum ejector 332. The impurity exhaust stream 354 (and the impurities 324 contained therein) are directed through the third valve 350, into the second suction port 364 of the vacuum ejector 332, out of the outlet port 360 of the vacuum ejector 332, through the mixer 378, and out of the exhaust 356 of the fuel cell system 310.

After the second adsorbent bed 330 is in the second desorption state, the second adsorbent bed 330 changes to the second pressurization state. In the second pressurization state of the second adsorbent bed 330, the third valve 350 is in the first open position and the fourth valve 352 is in a closed position so that the second adsorbent bed 330 is not fluidly coupled to the fuel cell 312. The third valve 350 fluidly couples the reactant intake 314 to the second adsorbent bed 330. The reactant stream 322 is directed through the third valve 350 and into the second adsorbent bed 330. Because the fourth valve 352 is in the closed position, the second adsorbent bed 330 is pressurized.

In some embodiments, the impurity removal system 316 includes a first pressure regulator 368 and/or a second pressure regulator 370, as shown in FIG. 11. In some embodiments, the first pressure regulator 368 is arranged downstream of the reactant intake 314 and upstream of the impurity removal system 316. The second pressure regulator 370 is arranged downstream of the impurity removal system 316 and upstream of the fuel cell 312. The first pressure regulator 368 reduces a pressure of the reactant stream 322 before the reactant stream 322 reaches the impurity removal system 316. The second pressure regulator 370 reduces a pressure of the purified reactant stream 326 before the purified reactant stream 326 reaches the inlet 318 of the fuel cell 312. Due to the second pressure regulator 370 downstream of the adsorbent beds 328, 330, the adsorbent beds 328, 330 may operate at a pressure higher than an operating pressure of the fuel cell 312. The higher operating pressure of the adsorbent beds 328, 330 allows for increased impurity removal efficiency with a larger pressure difference between pressurized and desorption states leading to a larger amount of desorbed contaminants (see FIG. 9).

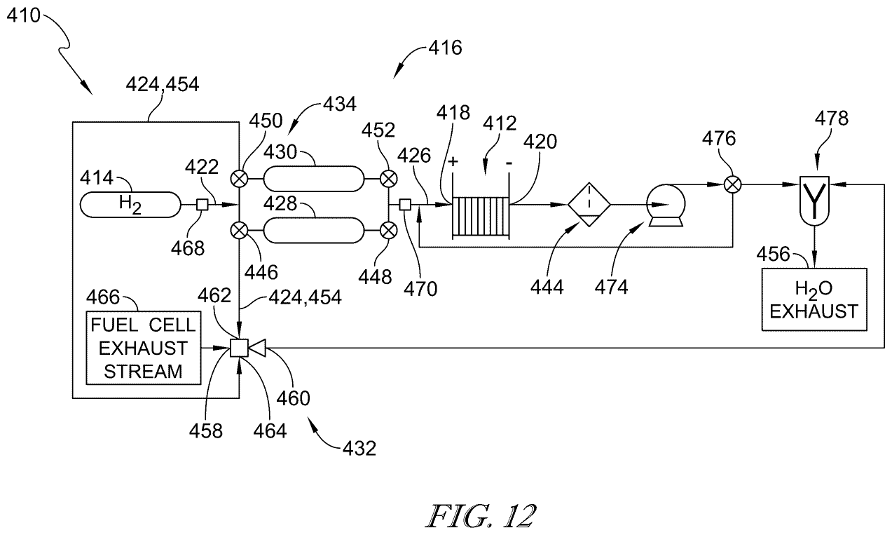

The present disclosure provides an alternative impurity removal system 416 for use with an alternative fuel cell system 410, as shown in FIG. 12. FIG. 12 illustrates another embodiment of an impurity removal system 416 that is substantially similar to the impurity removal system 216 and the impurity removal system 316. In the absence of disclosure to the contrary, the features and components of the impurity removal systems 216, 316 and the fuel cell systems 210, 310 are applicable and present for the impurity removal system 416 and the fuel cell system 410.

The fuel cell system 410 includes a fuel cell 412, a reactant intake 414, and the impurity removal system 416, as shown in FIG. 12. The fuel cell system 410 further includes a condenser 444, a recirculation pump 474, a purge valve 476, and/or a mixer 478. The fuel cell 412 includes an inlet 418 and an outlet 420 opposite the inlet 418. The reactant intake 414 is illustratively a hydrogen storage tank configured to inject and/or direct a reactant stream 422 toward the inlet 418 of the fuel cell 412. The purge valve 476 is a three-way valve. The purge valve 476 directs hydrogen from the recirculation pump 474 back toward the inlet 418 of the fuel cell 412 as recirculated hydrogen, as shown in FIG. 12.

The impurity removal system 416 is arranged between the reactant intake 414 and the fuel cell 412, as shown in FIG. 12. The impurity removal system 416 is configured to remove impurities 424 from the reactant stream 422 to form a purified reactant stream 426. The purified reactant stream 426 is directed into the inlet 418 of the fuel cell 412. The impurity removal system 416 includes a first adsorbent bed 428, a second adsorbent bed 430, a vacuum ejector 432, and/or a plurality of valves 434, as shown in FIG. 12.

In the illustrative embodiment, the plurality of valves 434 includes a first valve 446, a second valve 448, a third valve 450, and/or a fourth valve 452, as shown in FIG. 12. The first valve 446 is arranged between the reactant intake 414 and the first adsorbent bed 428. The second valve 448 is arranged between the first adsorbent bed 428 and the inlet 418 of the fuel cell 412. The third valve 450 is arranged between the reactant intake 414 and the second adsorbent bed 430. The fourth valve 452 is arranged between the second adsorbent bed 430 and the inlet 418 of the fuel cell 412.

The first adsorbent bed 428 operates the same as the first adsorbent bed 228 previously described by changing between a first active state, a first desorption state, and a first pressurization state. The second adsorbent bed 430 operates the same as the second adsorbent bed 230 previously described by changing between a second active state, a second desorption state, and a second pressurization state.

In the first active state of the first adsorbent bed 428, the first valve 446 is in a first open position and the second valve 448 is in an open position. The reactant stream 422 is directed through the first valve 446 and to the first adsorbent bed 428 to remove the impurities 424 therefrom and to form the purified reactant stream 426. The purified reactant stream 426 is directed through the second valve 448 and into the inlet 418 of the fuel cell 412. From the first active state, the first adsorbent bed 428 changes to the first desorption state.

In the first desorption state of the first adsorbent bed 428, the first valve 446 is in a second open position different from the first open position and the second valve 448 is in a closed position so that the first adsorbent bed 428 is not fluidly coupled to the fuel cell 412. The first valve 446 fluidly couples the vacuum ejector 432 to the first adsorbent bed 428.

The vacuum ejector 432 includes an inlet port 458, an outlet port 460, a first suction port 462, and/or a second suction port 464, as shown in FIG. 12. The inlet port 458 is fluidly coupled with the outlet 420 of the fuel cell 412 to receive a fuel cell exhaust stream 466 therefrom. The outlet port 460 is fluidly coupled with the mixer 478 and an exhaust 456 of the fuel cell system 410. The first suction port 462 is fluidly coupled with the first adsorbent bed 428 through the first valve 446. The second suction port 464 is fluidly coupled with the second adsorbent bed 430 through the third valve 450.

Within an impurity exhaust stream 454, the impurities 424 in the first adsorbent bed 428 are purged from the first adsorbent bed 428 via the vacuum ejector 432, as shown in FIG. 12. The impurity exhaust stream 454 (and the impurities 424 contained therein) are directed through the first valve 446, through the first suction port 462 of the vacuum ejector 432, out of the outlet port 460 of the vacuum ejector 432, through the mixer 478, and out of the exhaust 456 of the fuel cell system 410. The fuel cell exhaust stream 466 provides the aspiration necessary for the desorption of the first adsorbent bed 428.

From the first desorption state, the first adsorbent bed 428 changes to the first pressurization state. In the first pressurization state of the first adsorbent bed 428, the first valve 446 is in the first open position and the second valve 448 is in the closed position so that the first adsorbent bed 428 is not fluidly coupled to the fuel cell 412. The first valve 446 fluidly couples the reactant intake 414 to the first adsorbent bed 428. The reactant stream 422 is directed through the first valve 446 and into the first adsorbent bed 428. Because the second valve 448 is in the closed position, the first adsorbent bed 428 is pressurized.

While the first adsorbent bed 428 is in the first pressurization state, the second adsorbent bed 430 is in the second active state. In the second active state, the third valve 450 is in a first open position to fluidly couple the reactant intake 414 to the second adsorbent bed 430. The fourth valve 452 is in an open position to fluidly couple the second adsorbent bed 430 to the fuel cell 412. The reactant stream 422 is directed through the third valve 450 and into the second adsorbent bed 430 to remove the impurities 424 therefrom and to form the purified reactant stream 426 that is directed through the fourth valve 452 and into the inlet 418 of the fuel cell 412, as shown in FIG. 12.

After the second adsorbent bed 430 is in the second active state, the second adsorbent bed 430 changes to the second desorption state. In the second desorption state of the second adsorbent bed 430, the third valve 450 is in a second open position different from the first open position and the fourth valve 452 is in a closed position so that the second adsorbent bed 430 is not fluidly coupled to the fuel cell 412. The third valve 450 fluidly couples the vacuum ejector 432 to the second adsorbent bed 430. Within the impurity exhaust stream 454, the impurities 424 in the second adsorbent bed 430 are purged from the second adsorbent bed 430 via the vacuum ejector 432. The impurity exhaust stream 454 (and the impurities 424 contained therein) are directed through the third valve 450, into the second suction port 464 of the vacuum ejector 432, out of the outlet port 460 of the vacuum ejector 432, through the mixer 478, and out of the exhaust 456 of the fuel cell system 410.

After the second adsorbent bed 430 is in the second desorption state, the second adsorbent bed 430 changes to the second pressurization state. In the second pressurization state of the second adsorbent bed 430, the third valve 450 is in the first open position and the fourth valve 452 is in a closed position so that the second adsorbent bed 430 is not fluidly coupled to the fuel cell 412. The third valve 450 fluidly couples the reactant intake 414 to the second adsorbent bed 430. The reactant stream 422 is directed through the third valve 450 and into the second adsorbent bed 430. Because the fourth valve 452 is in the closed position, the second adsorbent bed 430 is pressurized.

In some embodiments, the impurity removal system 416 includes a first pressure regulator 468 and/or a second pressure regulator 470, as shown in FIG. 12. In some embodiments, the first pressure regulator 468 is arranged downstream of the reactant intake 414 and upstream of the impurity removal system 416. The second pressure regulator 470 is arranged downstream of the impurity removal system 416 and upstream of the fuel cell 412. The first pressure regulator 468 reduces a pressure of the reactant stream 422 before the reactant stream 422 reaches the impurity removal system 416. The second pressure regulator 470 reduces a pressure of the purified reactant stream 426 before the purified reactant stream 426 reaches the inlet 418 of the fuel cell 412. Due to the second pressure regulator 470 downstream of the adsorbent beds 428, 430, the adsorbent beds 428, 430 may operate at a pressure higher than the operating pressure of the fuel cell 412. The higher operating pressure of the adsorbent beds 428, 430 allows for improved impurity removal efficiency with a larger pressure difference between pressurized and desorption states leading to a larger amount of desorbed contaminants (see FIG. 9).

In some embodiments, the recirculation pump 374, 474 may be replaced with a venturi or an ejector. In some embodiments, the fuel cell system 310, 410 includes both the recirculation pump 374, 474 and an ejector. As hydrogen is typically supplied with a relatively low water partial pressure (e.g., less than about 5 part per million by volume), a condenser arranged upstream of the impurity removal system 416 is not necessary to protect adsorbents sensitive to water. As the hydrogen pressure is decreased during delivery, the hydrogen stream temperature may increase by about 5° C. to about 70° C., including any specific temperature or range of temperatures comprised therein. This increase in the hydrogen stream temperature may require cooling to maintain the operational efficiency of the adsorbent beds 428, 430 because species (i.e., impurities 224) more readily adsorb at the lower temperatures, as previously discussed (e.g., about 20° C. to about 40° C.).

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell system comprising:
a fuel cell including an inlet and an outlet opposite the inlet,
a reactant intake configured to direct a reactant stream toward the inlet of the fuel cell, and
an impurity removal system arranged downstream of the reactant intake and configured to remove impurities from the reactant stream to form a purified reactant stream that is directed into the inlet of the fuel cell, the impurity removal system including a first adsorbent bed, a second adsorbent bed, a vacuum ejector, and a plurality of valves,
wherein the first adsorbent bed changes between a first active state in which the reactant stream is directed through the first adsorbent bed to remove the impurities therefrom and to form the purified reactant stream that is directed into the inlet of the fuel cell, a first desorption state in which the impurities in the first adsorbent bed are purged from the first adsorbent bed via the vacuum ejector and out of an exhaust of the fuel cell system, and a first pressurization state in which the reactant stream is directed into the first adsorbent bed without being directed into the fuel cell to pressurize the first adsorbent bed.

2. The fuel cell system of claim 1, wherein the second adsorbent bed changes between a second active state in which the reactant stream is directed through the second adsorbent bed to remove the impurities therefrom and to form the purified reactant stream that is directed into the inlet of the fuel cell, a second desorption state in which the impurities in the second adsorbent bed are purged from the second adsorbent bed via the vacuum ejector and out of the exhaust of the fuel cell system, and a second pressurization state in which the reactant stream is directed into the second adsorbent bed without being directed into the fuel cell to pressurize the second adsorbent bed.

3. The fuel cell system of claim 2, wherein, in response to the first adsorbent bed being in the first active state, the second adsorbent bed is in the second desorption state or the second pressurization state, and in response to the second adsorbent bed being in the second active state, the first adsorbent bed is in the first desorption state or the first pressurization state so that the purified reactant stream is continuously supplied to the inlet of the fuel cell.

4. The fuel cell system of claim 2, wherein the plurality of valves includes a first valve upstream of the first adsorbent bed, a second valve downstream of the first adsorbent bed, a third valve upstream of the second adsorbent bed, and a fourth valve downstream of the second adsorbent bed.

5. The fuel cell system of claim 4, wherein, while the first adsorbent bed is in the first active state, the first valve is in a first open position and the reactant stream is directed into the first adsorbent bed through the first valve, and the second valve is in an open position and the purified reactant stream is directed through the second valve and into the inlet of the fuel cell, and
wherein, while the second adsorbent bed is in the second pressurization state, the third valve is in a first open position and the reactant stream is directed through the third valve and into the second adsorbent bed, and the fourth valve is in a closed position so that the reactant stream is not directed to the fuel cell from the second adsorbent bed and the second adsorbent bed is pressurized via the reactant stream.

6. The fuel cell system of claim 5, wherein, while the first adsorbent bed is in the first desorption state, the first valve is in a second open position different than the first open position of the first valve and the impurities in the first adsorbent bed are directed through the first valve and out of the first adsorbent bed, through the vacuum ejector, and to the exhaust, and the second valve is in a closed position, and
wherein, while the second adsorbent bed is in the second active state, the third valve is in the first open position and the reactant stream is directed through the third valve and into the second adsorbent bed, and the fourth valve is in an open position and the purified reactant stream is directed through the fourth valve and into the inlet of the fuel cell.

7. The fuel cell system of claim 6, wherein, while the first adsorbent bed is in the first pressurization state, the first valve is in the first open position and the reactant stream is directed through the first valve and into the first adsorbent bed, and the second valve is in the closed position so that the reactant stream is not directed to the fuel cell from the first adsorbent bed and the first adsorbent bed is pressurized via the reactant stream, and
wherein, while the second adsorbent bed is in the second active state, the third valve is in the first open position and the reactant stream is directed through the third valve and into the second adsorbent bed, and the fourth valve is in the open position and the purified reactant stream is directed through the fourth valve and into the inlet of the fuel cell.

8. The fuel cell system of claim 7, wherein, while the first adsorbent bed is in the first active state, the first valve is in the first open position and the reactant stream is directed through the first valve and into the first adsorbent bed, and the second valve is in the open position and the purified reactant stream is directed through the second valve and into the inlet of the fuel cell, and
wherein, while the second adsorbent bed is in the second desorption state, the third valve is in a second open position different than the first open position of the third valve and the impurities in the second adsorbent bed are directed out of the second adsorbent bed through the third valve, through the vacuum ejector, and to the exhaust, and the fourth valve is in a closed position.

9. The fuel cell system of claim 4, wherein the impurity removal system further comprises a first contaminant sensor arranged upstream of the first valve and the third valve.

10. The fuel cell system of claim 9, wherein the impurity removal system further comprises a second contaminant sensor arranged between the first adsorbent bed and the second valve, and wherein data from the first contaminant sensor and data from the second contaminant sensor are compared to determine a contaminant removal efficiency of the first adsorbent bed.

11. The fuel cell system of claim 10, wherein the impurity removal system further comprises a third contaminant sensor arranged between the second adsorbent bed and the fourth valve, and wherein the data from the first contaminant sensor and data from the third contaminant sensor are compared to determine a contaminant removal efficiency of the second adsorbent bed.

12. The fuel cell system of claim 1, further comprising a filter arranged upstream of the impurity removal system.

13. A method of operating a fuel cell system comprising:
arranging an impurity removal system downstream of a reactant intake, the impurity removal system including a first adsorbent bed, a second adsorbent bed, a vacuum ejector, a first valve, a second valve, a third valve, and a fourth valve,
directing a reactant stream into the reactant intake of the fuel cell system,
changing the first adsorbent bed to a first active state by opening the first valve to a first open position and opening the second valve to an open position,
changing the second adsorbent bed to a second pressurization state by opening the third valve to a first open position and closing the fourth valve to a closed position,
directing the reactant stream through the first valve and into the first adsorbent bed to remove impurities therefrom and to form a purified reactant stream,
directing the reactant stream through the third valve and into the second adsorbent bed to pressurize the second adsorbent bed, and
directing the purified reactant stream from the first adsorbent bed, through the second valve, and into the fuel cell.

14. The method of claim 13, further comprising changing the first adsorbent bed to a first desorption state from the first active state by opening the first valve to a second open position different than the first open position and closing the second valve to a closed position,
directing the impurities in the first adsorbent bed through the first valve, through the vacuum ejector, and out of an exhaust,
changing the second adsorbent bed to a second active state from the second pressurization state by opening the fourth valve to an open position,
directing the reactant stream through the third valve, into the second adsorbent bed to remove the impurities therefrom and to form the purified reactant stream, and
directing the purified reactant stream from the second adsorbent bed, through the fourth valve, and into the fuel cell.

15. The method of claim 14, further comprising changing the first adsorbent bed to a first pressurization state from the first desorption state by opening the first valve to the first open position, and
directing the reactant stream through the first valve and into the first adsorbent bed to pressurize the first adsorbent bed.

16. The method of claim 15, further comprising changing the first adsorbent bed to the first active state from the first pressurization state by opening the second valve to the open position,
directing the reactant stream through the first valve, into the first adsorbent bed to remove the impurities therefrom and to form the purified reactant stream, and
directing the purified reactant stream from the first adsorbent bed, through the second valve, and into the fuel cell.

17. The method of claim 16, further comprising changing the second adsorbent bed to a second desorption state from the second active state by opening the third valve to a second open position different than the first open position of the third valve and closing the fourth valve to the closed position, and
directing the impurities in the second adsorbent bed through the third valve, through the vacuum ejector, and out of the exhaust.

18. The method of claim 13, wherein the impurity removal system includes a first contaminant sensor arranged upstream of the first valve and the third valve and a second contaminant sensor arranged between the first adsorbent bed and the second valve, and
wherein the method further comprises comparing data from the first contaminant sensor and data from the second contaminant sensor to determine a contaminant removal efficiency of the first adsorbent bed.

19. The method of claim 18, wherein the impurity removal system includes a third contaminant sensor arranged between the second adsorbent bed and the fourth valve, and
wherein the method further comprises comparing the data from the first contaminant sensor and data from the third contaminant sensor to determine a contaminant removal efficiency of the second adsorbent bed.

20. The method of claim 13, further comprising arranging a filter upstream of the impurity removal system.
